(19) United States
(12) Patent Application Publication
(10) Pub. No.: US 2007/0057019 A1
(43) Pub. Date: Mar. 15, 2007

(54) HEATABLE ROLL AND PROCESS FOR MAKING A HEATABLE ROLL

(75) Inventors: Thomas Baumeister, Toenisvorst (DE); Peter Wiemer, Korschenbroich (DE); Hans-Rolf Conrad, Dormagen (DE); Ralf Beckers, Kempen (DE); Christian Loeffler, Geldern (DE); Jochen Autrata, Neukirchen-Vluyn (DE); Heiko Linder, Neukirchen-Vluyn (DE); Olaf Dries, Ratingen (DE); Andreas Essling, Bocholt (DE); Franz-Josef Michelkens, Grefrath (DE)

Correspondence Address: GREENBLUM & BERNSTEIN, P.L.C., 1950 ROLAND CLARKE PLACE, RESTON, VA, 20191, US

(73) Assignee: VOITH PAPER PATENT GMBH, Heidenheim (DE)

(21) Appl. No.: 11/466,334

(22) Filed: Aug. 22, 2006

(30) Foreign Application Priority Data
Aug. 29, 2005 (DE) 10 2005 040 869.9

(51) Int. Cl. A47J 36/02

(52) U.S. Cl. 228/101

(57) ABSTRACT

A heatable roll having a smooth, hard surface for the production and/or treatment of a fibrous web, in particular a paper, board or tissue web, comprises a base tube made of weldable steel, to which at least one welded layer which has a higher hardness than the base tube is applied. Moreover, a process for the production of such a roll is described.

### CROSS-REFERENCE TO RELATED APPLICATIONS

The present application claims priority under 35 U.S.C. §119 of German Patent Application No. 10 2005 040 869.9, filed on Aug. 29, 2005, the disclosure of which is expressly incorporated by reference herein in its entirety.

### BACKGROUND OF THE INVENTION

1. Field of the Invention

The invention relates to a heatable roll having a smooth, hard surface for the production and/or treatment of a fibrous web, in particular a paper, board or tissue web. The invention also relates to a process for the production of such a roll.

2. Discussion of Background Information

Until now, only hard cast rolls or forged and inductively hardened steel rolls have been used as heatable rolls having a particularly smooth, hard surface. Both types of roll are expensive to purchase and can be obtained only in specific dimensions, i.e., relatively large sizes. In addition, these known types of rolls have problems with inherent stresses and do not have very high wear resistance.

It has also been found that considerable problems also arise in the case of the previously known rolls with regard to maintaining a specific hardness layer thickness. That is, maintaining a specific hardness layer has a detrimental effect on the dimensional stability of such rolls. By example, in the case of inductively hardened forged steel rolls, although the depth of the hardness can be defined relatively accurately, there is an inherent stress peak at the transition between the hardened and unhardened layer. Added to this is the fact that a hard cast roll can only be repaired after the roll is turned down, i.e., shut-off. Finally, in the case of a roll of hard cast material, an increasing rise in hardness always occurs radially from inside to outside, which means that boring heating ducts axially through the roll shell is made considerably more difficult.

In addition to hard cast rolls and hardened steel rolls, chromium cast rolls are also used. Additionally, what is known as “armor welding” is already known, for example, in the case of wheels of railbound vehicles and in the case of steel rolling mills.

### SUMMARY OF THE INVENTION

The invention provides an improved roll and an improved process of making a roll, which eliminates the above-noted problems.

With regard to a heatable roll, the invention comprises a base tube made of weldable steel and at least one welded layer which has a higher hardness than the base tube. The base tube of the roll can be fabricated from relatively simple weldable steel, while the one or more hard welded layers are applied over the base tube. The welded layer preferably comprises a metal alloy that can be welded to the base tube. In this case, in principle, all metal alloys which can be welded to the base tube are suitable.

The welded layer is preferably applied spirally to the base tube. The layer can therefore be welded on spirally, for example, with the base tube rotating.

The roll preferably has a surface hardness according to Vickers of about ≧450 HV. With the application according to the invention of a welded layer, surface hardnesses above such a value of about 450 HV can be achieved without difficulty. (Conventional hard cast rolls have hardnesses of about 530 HV.) With the application according to the invention of a welded layer, hardnesses up to, for example, about 800 HV, can be achieved.

According to a preferred embodiment of the roll according to the invention, the welded layer has a surface hardness according to Vickers of >530 HV. In further embodiments, the welded layer has a surface hardness according to Vickers of about ≧600, in particular about ≧700, in particular about ≧750 and preferably about 800 HV. The surface hardness according to Vickers can be in a range from about 450 to about 800 HV and preferably in a range from about 530 to about 800 HV.

The welded layer can be formed by one layer of welding or by a plurality of layers. In this case, the thickness of a respective layer of welding is preferably about 3 mm. The total thickness of the welded layer following the final machining of the surface, for example by turning or grinding, is in a range from about 1 to about 20 mm, preferably in a range from about 3 to about 10

Since the layer or metal alloy to be welded has constituents that can be determined relatively easily, the physical and chemical properties of the layer and of the various layers can be set variably. According to an embodiment, the hardness of the welded layer increases radially outward, starting from the base tube, which means that inherent stresses are reduced.

The heatable roll can be a rotating hollow roll with flange-mounted journals. The roll is provided with peripheral heating ducts or bores, preferably extending parallel to the roll axis. A wall thickness of the heatable roll lies in a range from about 100 to about 200 mm. The base tube of the heatable roll can be comprised of a forged tube, a seamlessly drawn tube or turned round steel.

With regard to the process, the at least one welded layer can be applied to the base tube of weldable steel. The at least one welded layer has a higher hardness than the base tube. The welded layer is welded under powder or under inert gas and by means of an addition of material in the form of at least one strip or wire. The welded layer can be applied spirally with the base body rotating.

Moreover, the invention relates generally to a process for the production of a roll for use in paper production, which can therefore be used not only for the production of heating rolls but also for the production of other rolls used in paper production or treatment. According to the invention, this process includes at least one welded layer applied to a bas tube of weldable steel. The final material properties of the coating following the welding application are set by an appropriate heat treatment. In this case, the heat treatment can comprise an annealing treatment.

In further aspects of the invention, a heatable roll comprises a base tube made of weldable steel and at least one welded layer provided on the base tube. The at least one welded layer has a higher hardness than the base tube.

In embodiments, the welded layer comprises a metal alloy. The welded layer is spirally applied on the base tube. The welded layer has a surface hardness according to Vickers of about ≧450 HV. The welded layer has a surface hardness according to Vickers of ≧530 HV. The welded layer has a surface hardness according to Vickers of ≧600. The welded layer has a surface hardness according to Vickers of ≧700. The welded layer has a surface hardness according to Vickers of about 800 HV. The welded layer has a surface hardness according to Vickers in a range from about 450 to about 800 HV. The welded layer has hardness according to Vickers in a range from about 530 to about 800 HV.

The welded layer is at least two layers. A thickness of a respective layer of the at least one welding layer is about 3 mm. A total thickness of the welded layer following final machining is in a range from about 1 to about 20 mm. The total thickness of the welded layer following final machining is in a range from about 3 to about 10 mm. A hardness of the welded layer increases radially outward, starting from the base tube.

In embodiments, the roll comprises flange-mounted journals. The base tube comprises peripheral heating ducts or bores. The peripheral heating ducts or bores extend parallel to a roll axis. The roll has a wall thickness in a range from about 100 to about 200 mm.

In embodiments, the base tube is a forged tube. In embodiments, the base tube is a seamlessly drawn tube. In embodiments, the base tube is turned round steel. In embodiments, the welded layer is provided in conjunction with a tungsten carbide layer. The roll has a surface for production and/or treatment of a fibrous web.

In another aspect of the invention, a process for the production of a heatable roll provided with a smooth, hard surface, comprises providing a base tube of weldable steel and applying at least one welded layer over the base tube. The at least one welded layer has a higher hardness than the base tube.

In embodiments, the welded layer is carried out under powder or under inert gas and by an addition of material in the form of at least one strip or wire. The welded layer is formed by a metal alloy. The process includes rotating the base tube to spirally apply the welded layer to the base tube. The welded layer is applied to the base tube continuously by circumferential welding, then a lateral step by one weld seam width, then circumferential welding and repeating such steps until the welded layer is applied to the base tube.

In another aspect of the invention, a process for the production of a roll for use in paper production comprises applying at least one welded layer to a base tube of weldable steel and heat treating the at least one welded layer such that final material properties following the applying step are set.

In embodiments of the process, the heat treatment comprises an annealing treatment. The set material properties comprise at least one of ductility, grain structure, dimensional stability, inherent stress and hardness. The at least one welded layer has a higher hardness than the base tube. The welded layer is provided in conjunction with a tungsten carbide layer. The applying step is a welding application. The heat treating is carried out in a range from about 100° to 250° C.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a cut-away plan view of a heatable roll according to the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

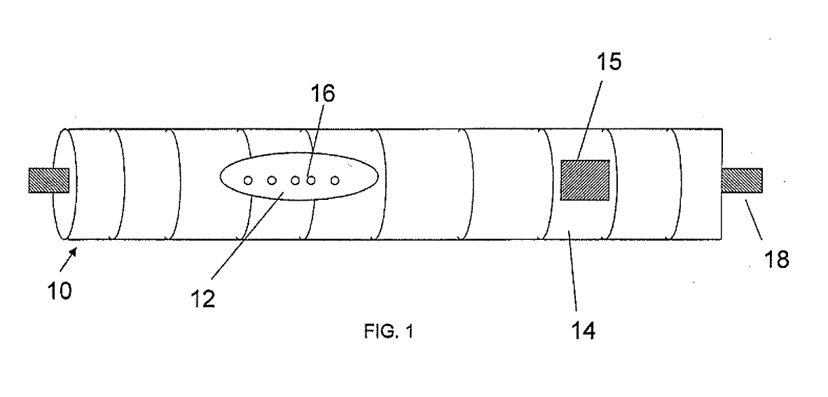

FIG. 1 shows a cut-away plan view of the heatable roll according to the invention. As shown, the heatable roll 10 comprises a base tube 12 made of weldable steel and at least one welded layer 14 provided on the base tube 12. The at least one welded layer 14 has a higher hardness than the base tube 12. In embodiments, the welded layer 14 is spirally applied on the base tube 12. The welded layer 14 can be two or more layers. In embodiments, the welded layer 14 is provided in conjunction with a tungsten carbide layer 15 (represented graphically). The welded layer 14 comprises a metal alloy.

In embodiments, the base tube 12 is a forged tube. In other embodiments, the base tube 12 is a seamlessly drawn tube or is turned round steel.

In embodiments, the welded layer 14 can have a surface hardness according to Vickers of about ≧450 HV. In further embodiments, the welded layer 14 can have a surface hardness according to Vickers of >530 HV, and in particular a surface hardness according to Vickers of ≧600 HV, and more particularly a surface hardness according to Vickers of ≧700 HV. In one preferred embodiment, the welded layer 14 has a surface hardness according to Vickers of about 800 HV, and in particular in a range from about 450 to about 800 HV, and even more particularly in a range from about 530 HV to about 800 HV.

A thickness of a respective layer of the at least one welded layer 14 is about 3 mm. A total thickness of the welded layer 14 following final machining is in a range from about 1 to about 20 mm, and more particularly in a range from about 3 to about 10 mm. A hardness of the welded layer 14 increases radially outward, starting from the base tube 12. The roll 10 has a wall thickness in a range from about 100 to about 200 mm.

In embodiments, the roll 10 comprises flange-mounted journals 18. Additionally, the base tube 12 comprises peripheral heating ducts or bores 16. The peripheral heating ducts or bores 16 extend parallel to a roll axis. The roll has a smooth surface for production and/or treatment of a fibrous web. The smooth surface is defined by a roughness value Ra in a range from about 0.01 to about 0.2 μm.

In another aspect of the invention, a process for the production of a heatable roll provided with a smooth, hard surface, comprises providing a base tube of weldable steel and applying at least one welded layer over the base tube. The at least one welded layer has a higher hardness than the base tube.

In embodiments, the welded layer 14 is carried out under powder or under inert gas and by an addition of material in the form of at least one strip or wire. The process includes rotating the base tube 12 to spirally apply the welded layer 14 to the base tube 12. The welded layer 14 is applied to the base tube 12 continuously by circumferential welding, then a lateral step by one weld seam width, then circumferential welding and repeating such steps until the welded layer 14 is applied to the base tube 12.

In embodiments, the heat treatment comprises an annealing treatment. The heat treatment can set material properties such as, for example, ductility, grain structure, dimensional stability, inherent stress and hardness.

In the roll according to the invention, the inherent stresses can be considerably reduced. As a result, when the roll is heated to temperatures in a range from 100° to 250° C., the sum of inherent stresses and external stresses falls to a level which can easily be managed. Also, in contrast to the conventional rolls, a constant hardness layer thickness can be achieved, according to the invention, which brings with it considerably improved dimensional stability and better dynamic running behavior of the roll.

A further decisive advantage of the heatable roll according to the invention is that it offers improved repair possibilities. For example, in the case the roll is damage, the repair of the roll can be carried out by renewed application of welding.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A heatable roll, comprising:
a base tube made of weldable steel; and
at least one welded layer provided on the base tube which has a higher hardness than the base tube.

2. The roll as claimed in claim 1, wherein the welded layer comprises a metal alloy.

3. The roll as claimed in claim 1, wherein the welded layer is spirally applied on the base tube.

4. The roll as claimed in claim 1, wherein the welded layer has a surface hardness according to Vickers of about ≧450 HV.

5. The roll as claimed in claim 4, wherein the welded layer has a surface hardness according to Vickers of ≧530 HV.

6. The roll as claimed in claim 5, wherein the welded layer has a surface hardness according to Vickers of ≧600 HV.

7. The roll as claimed in claim 6, wherein the welded layer has a surface hardness according to Vickers of ≧700 HV.

8. The roll as claimed in claim 7, wherein the welded layer has a surface hardness according to Vickers of about 800 HV.

9. The roll as claimed in claim 1, wherein the welded layer has a surface hardness according to Vickers in a range from about 450 to about 800 HV.

10. The roll as claimed in claim 1, wherein the welded layer has a hardness according to Vickers in a range from about 530 to about 800 HV.

11. The roll as claimed in claim 1, wherein the welded layer is at least two layers.

12. The roll as claimed in claim 1, wherein a thickness of a respective layer of the at least one welded layer is about 3 mm.

13. The roll as claimed in claim 1, wherein a total thickness of the welded layer following final machining is in a range from about 1 to about 20 mm.

14. The roll as claimed in claim 13, wherein the total thickness of the welded layer following final machining is in a range from about 3 to about 10 mm.

15. The roll as claimed in claim 1, wherein a hardness of the welded layer increases radially outward, starting from the base tube.

16. The roll as claimed in claim 1, wherein the roll comprises flange-mounted journals.

17. The roll as claimed in claim 1, wherein the base tube comprises peripheral heating ducts or bores.

18. The roll as claimed in claim 17, wherein the peripheral heating ducts or bores extend parallel to a roll axis.

19. The roll as claimed in claim 1, wherein the roll has a wall thickness in a range from about 100 to about 200 mm.

20. The roll as claimed in claim 1, wherein the base tube is a forged tube.

21. The roll as claimed in claim 1, wherein the base tube is a seamlessly drawn tube.

22. The roll as claimed in claim 1, wherein the base tube is turned round steel.

23. The roll as claimed in claim 1, wherein the welded layer is provided in conjunction with a tungsten carbide layer.

24. The roll as claimed in claim 1, wherein the roll has a smooth surface for production and/or treatment of a fibrous web, wherein the smooth surface is defined by a roughness value Ra in a range from about 0.01 to about 0.2 μm.

25. A process for the production of a heatable roll provided with a smooth, hard surface, comprising:
providing a base tube of weldable steel; and
applying at least one welded layer over the base tube,
wherein the at least one welded layer has a higher hardness than the base tube.

26. The process as claimed in claim 25, wherein the welded layer is applied under powder or under inert gas and by an addition of material in the form of at least one strip or wire.

27. The process as claimed in claim 25, wherein the welded layer is formed by a metal alloy.

28. The process as claimed in claim 25, further comprising rotating the base tube to spirally apply the welded layer to the base tube.

29. The process as claimed in claim 25, wherein the welded layer is applied to the base tube continuously by circumferential welding, then a lateral step by one weld seam width, then circumferential welding and repeating such steps until the welded layer is applied to the base tube.

30. The process as claimed in claim 25, wherein the welded layer has a surface hardness according to Vickers of about ≧450 HV.

31. The process as claimed in claim 30, wherein the welded layer has a surface hardness according to Vickers of ≧530 HV.

32. The process as claimed in claim 30, wherein the welded layer has a surface hardness according to Vickers of ≧ 600 HV.

33. The process as claimed in claim 30, wherein the welded layer has a surface hardness according to Vickers of ≧700 HV.

34. The process as claimed in claim 30, wherein the welded layer has a surface hardness according to Vickers of ≧750 HV.

35. The process as claimed in claim 30, wherein a surface hardness of the welded layer according to Vickers is about 800 HV.

36. The process as claimed in claim 25, wherein the welded layer has a surface hardness according to Vickers in a range from about 450 to about 800 HV.

37. The process as claimed in claim 36, wherein the welded layer has a surface hardness according to Vickers in a range from about 530 to about 800 HV.

38. The process as claimed in claim 25, wherein the welded layer is at least two layers.

39. The process as claimed in claim 25, wherein a thickness of a respective layer of the at least one welded layer is about 3 mm.

40. The process as claimed in claim 25, wherein a total thickness of the at least one welded layer following final machining is in a range from about 1 to about 20 mm.

41. The process as claimed in claim 40, wherein the total thickness of the at least one welded layer is in a range from about 3 to about 10 mm.

42. The process as claimed in claim 25, wherein the welded layer has a hardness increasing radially outward, starting from the base tube.

43. The process as claimed in claim 25, wherein the roll is fabricated with a wall thickness in a range from about 100 to about 200 mm.

44. The process as claimed in claim 25, wherein the base tube is formed by a forged tube.

45. The process as claimed in claim 25, wherein the base tube is formed by a seamlessly drawn tube.

46. The process as claimed in claim 25, wherein the base tube is formed from turned round steel.

47. A process for the production of a roll for use in paper production, comprising:
applying at least one welded layer to a base tube of weldable steel; and
heat treating the at least one welded layer such that set material properties following the applying are set.

48. The process as claimed in claim 47, wherein the heat treating comprises an annealing treatment.

49. The process as claimed in claim 47, wherein the set material properties comprise at least one of ductility, grain structure, dimensional stability, inherent stress and hardness.

50. The process as claimed in claim 47, wherein the at least one welded layer has a higher hardness than the base tube.

51. The process as claimed in claim 47, wherein the welded layer is provided in conjunction with a tungsten carbide layer.

52. The process as claimed in claim 471 wherein the applying is a welding application.

53. The process as claimed in claim 47, wherein the heat treating is carried out in a range from about 100° to 250° C.
